(19) United States
(12) Patent Application Publication
(10) Pub. No.: US 2017/0158543 A1
(43) Pub. Date: Jun. 8, 2017

(54) Method and Apparatus For Additive Manufacturing of Objects Using Droplets of Molten Glass

(71) Applicant: Spiral Arts, Inc., Seattle, WA (US)

(72) Inventors: Fred Metz, Seattle, WA (US); Matthew Sorensen, Seattle, WA (US)

(73) Assignee: Spiral Arts, Inc., Seattle, WA (US)

(21) Appl. No.: 15/369,357

(22) Filed: Dec. 5, 2016

Related U.S. Application Data
(60) Provisional application No. 62/263,645, filed on Dec. 5, 2015.

(51) Int. Cl. C03B 19/00; C03B 7/098; B33Y 50/02; B33Y 70/00; B33Y 30/00; B33Y 10/00

(52) U.S. Cl. CPC C03B 19/00; B33Y 30/00; B33Y 10/00; B33Y 50/02; B33Y 70/00; C03B 7/098

(57) ABSTRACT

Provided is a method and apparatus for building a structure of glass using additive manufacturing technology. The apparatus incorporates a method of depositing molten glass material in discrete droplets rather than as a continuous fused filament. The additive manufacturing of glass material relies on the surface tension, the high viscosity of the molten glass, and droplet formation to control deposition by melting the glass filament directly without the use of a needle or crucible.

This application claims the benefit of priority under 35 U.S.C. §119(e) to U.S. Provisional Application No. 62/263,645 filed on Dec. 5, 2015 which is herein incorporated by reference in its entirety.

### TECHNICAL FIELD

Provided is a method and apparatus for building a structure in glass using additive manufacturing technology. The apparatus incorporates a method of depositing material in discrete droplets rather than as a continuous fused filament.

### BACKGROUND

While 3D printing of plastics is well established and approaching mainstream, the current challenges to the 3D printing industry lie in expanding the palette of printing materials beyond plastics, such as biological materials, metals, fabrics, complex plastics, and glass.

The present disclosure is the result of a project whose purpose was to explore the possibilities of 3D printing of glass structures. The only type of glass printing that had been conducted prior to the present disclosure was a powder printing process. Prior to the present disclosure, no one had attempted or had developed the method and apparatus to print directly with molten glass.

Most plastics print under 300° C. In contrast, most glasses liquefy at 1000-1600° C. The high temperature environment requires novel methods for additive manufacturing. Current methods of printing in glass, developed by a group at MIT, rely on the molten material passing through a nozzle fed by gravity. Nozzles fail to meter certain molten materials and the flow rates can be uneven. Additionally, nozzles are difficult to design for materials like glass since they need to maintain extremely high temperatures to liquefy the glass. Nozzles are unable to meter the delivery of glass accurately, and additionally suffer from rapid wear due to extreme conditions and corrosivity of molten glass. Thus, these nozzles of specialized material need to be replaced often, which could be costly. Furthermore, the use of nozzles with glass requires heating a bulk amount of glass which takes time to be effective and which requires the use of multiple heat sources.

Thus, there is a need for a method and apparatus to additively manufacture glass objects which overcomes the above mentioned nozzle, economic, and time deficiencies.

### SUMMARY

Disclosed herein are methods and apparatus that provide for the additive manufacturing of glass. The disclosure is directed to the additive manufacturing of glass material relying on surface tension, the high viscosity of the molten glass, and droplet formation to control deposition by melting the glass filament directly. In this way, the printer possesses the ability deposit discrete amounts of glass material.

Accordingly, in one embodiment of the present application, an apparatus for printing glass includes a computer control unit which controls the operation of various components of the apparatus; a fiber handling unit which operates as a supply source for glass fiber; a fiber feed unit which advances glass fiber from the fiber handling unit towards a primary heat source and which retracts glass fiber from the primary heat source towards the fiber handling unit; a heat source which melts an end tip of glass fiber creating a droplet of molten glass; and a deposition surface for receiving droplets of molten glass.

In some embodiments, the fiber handling unit includes a motor, which rotates the fiber handing unit to wind or unwind a reel of glass fiber and is in communication with the computer control unit.

In some embodiments, the fiber feed unit includes a motor-controlled wheel assembly that grips the glass fiber from the fiber handing unit and advances and retracts the glass fiber towards, through and away from the heat source. The fiber feed unit advances the glass fiber to a heating zone of the heat source in order to form a molten glass droplet on the tip of the glass fiber, wherein the fiber feed unit continuously advances the fiber at a grow rate to grow the molten glass droplet, located on the tip of the fiber, to a desired molten glass droplet size. When a desired droplet size is reached the fiber feed unit advances the glass fiber, holding the molten glass droplet located on the tip of the fiber with surface tension, at a deposition rate to advance the molten glass droplet to contact the deposition surface.

In some embodiments, the apparatus includes at least one tension sensor. The one tension sensor measures the tension of the glass fiber and is in communication with the computer control unit. The tension sensor may be incorporated into the fiber handling unit, the fiber feed unit, or both the fiber handling and fiber feed units.

In some embodiments, the fiber feed unit advances the fiber at a grow rate, synchronized to the rate at which a newly-fed fiber melts, to grow the molten glass droplet, located on the tip of the fiber, to a desired molten glass droplet size.

In some embodiments, the fiber feed unit advances the glass fiber, holding the molten glass droplet located on the tip of the fiber, at a deposition rate, faster than the rate at which a newly-fed fiber melts, to advance the molten glass droplet to contact the deposition surface.

The apparatus may include a fiber tube, positioned between the fiber handling unit and fiber feed unit that guides the glass fiber from the fiber handing unit to alignment with the fiber feed unit.

In some embodiments, the deposition surface of the apparatus may be raised to contact and accept a molten droplet of glass.

The heat source may be selected from an oxygen-fuel flame, a stream of gas heated with a resistive element, a stream of gas heated with electrical discharge, lasers, infrared radiation, an electric arc, or any combination thereof.

In some embodiments, the heat source is an electric arc created by two spaced apart electrodes, wherein the space between the electrodes defines a heating zone, wherein the electric arc is about 1 cm in length and the glass fiber is advanced into the heating zone and the electric arc heats the end tip of the glass fiber creating a molten glass droplet on the tip of the glass fiber.

In some embodiments, the fiber feed unit continuously advances the fiber at a grow rate synchronized to the rate at which a newly-fed fiber melts, to grow the molten glass droplet to a desired molten glass droplet size and selectively advances the glass fiber at a deposition rate to advance the molten glass droplet to contact the deposition surface.

In some embodiments, the apparatus includes at least two fiber handling units which each operate to supply a different source of glass fiber and at least two fiber feed units each which advances a glass fiber from an associated fiber handling unit.

Also provided is a method for printing glass on a material. The method includes the following steps: providing a glass fiber; feeding the glass fiber from a fiber handling unit; advancing and retracting the glass fiber with a fiber feed unit; heating an end tip of the glass fiber with a heat source to create a molten glass droplet; and, depositing the molten glass droplet on a substrate surface, wherein a computer control unit controls the operation of various components of the apparatus.

In some embodiments, the method may include any one of the following steps alone or in combination: winding and unwinding the glass fiber on a reel by a motor of the fiber handling unit in communication with the computer control unit; measuring the tension of the glass fiber by at least one tension sensor that is in communication with the computer control unit, and wherein the at least one tension sensor is incorporated into the fiber handling unit, the fiber feed unit, or both the fiber handling and fiber feed units; gripping the glass fiber and advancing and retracting the glass fiber towards, through and away from the heat source; guiding the glass fiber with a fiber tube, positioned between the fiber handling unit and fiber feed unit, from the fiber handing unit to alignment with the fiber feed unit; continuously advancing the glass fiber at a grow rate, to grow the molten glass droplet to a desired size and advancing the glass fiber at a deposition rate, to advance the molten glass droplet held by the glass fiber to the deposition surface; heating the tip of the glass fiber with an electric arc in a heating zone, wherein the heating zone is defined by the space between two spaced apart electrodes; growing the molten glass droplet to a desired size by continuously advancing the glass fiber at a grow rate synchronized to the rate at which a newly-fed fiber melts, while keeping the molten glass droplet in the heating zone; and depositing the molten glass droplet on a deposition surface by advancing the glass fiber at deposition rate, faster than the rate at which a newly-fed fiber melts, advancing the glass fiber and molten glass droplet though the heating zone.

An alternative method for printing glass on a material is also provided. This method includes the following steps: providing at least two glass fibers; feeding each of the glass fibers from an associated fiber handling unit; advancing and retracting each of the glass fibers with an associated fiber feed unit; selectively advancing one of the glass fibers to a heating zone of a heat source; heating an end tip of one of the glass fibers with a heat source to create a molten glass droplet; and depositing the molten glass droplet on a substrate surface, wherein a computer control unit controls the operation of various components of the apparatus, and selects which of the at least two glass fibers to advance.

In some embodiments of the method described above: at least two of the glass fibers may have different coefficients of thermal expansion; at least one glass fiber may be deposited as a fabrication object and at least one glass fiber is deposited as a removable mechanical support structures; and removal of the mechanical support structures may be facilitated by the automatic formation of fractures upon cooling of the deposited mechanical support structures.

### BRIEF DESCRIPTION OF THE DRAWINGS

Features and advantages of the invention will become apparent from the following detailed description made with reference to the accompanying drawings, wherein:

FIG. 1 is a schematic representation of one embodiment of the glass printing apparatus;

FIG. 2 is a schematic representation of a glass printing process;

FIG. 3 is a front view of a glass printing apparatus;

FIG. 4 is a side view of a glass printing apparatus;

FIG. 5 is a front view of a printing head of a glass printing apparatus;

FIG. 6 is a side view of a printing head of a glass printing apparatus;

FIG. 7 is a top view of a printing head of a glass printing apparatus;

FIG. 8 is a perspective view of a printing head of a glass apparatus and deposition surface; and

FIG. 9 is a glass structure on a deposition surface made by an apparatus as described herein.

### DETAILED DESCRIPTION

A more complete understanding of the components, processes and apparatus disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or define or limit the scope of the exemplary embodiments.

Although specific terms are used in the following description for the sake of clarity, these terms are intended to refer only to the particular structure of the embodiments selected for illustration in the figures, and are not intended to define or limit the scope of the disclosure. In the figures and following description below, it is understood that like numeric designations refer to components of like function.

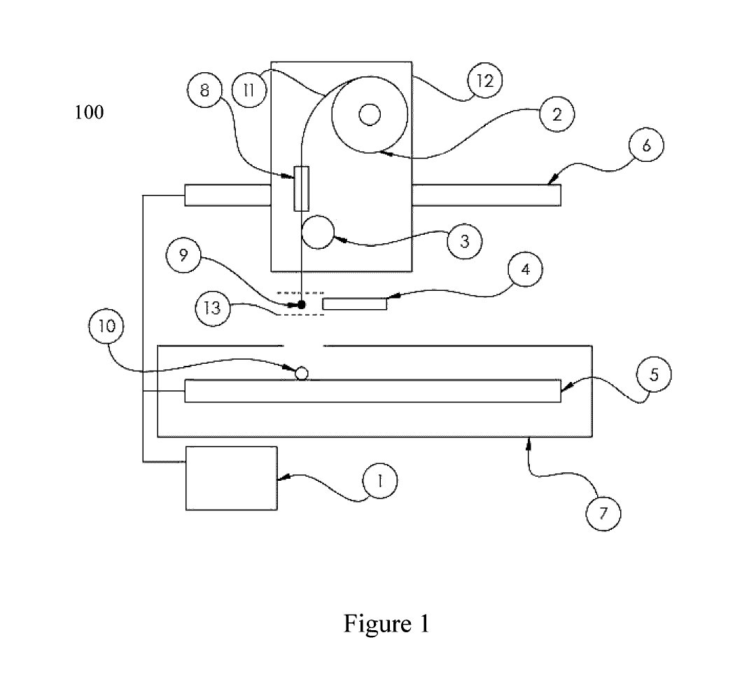

FIG. 1 illustrates a glass printing apparatus in accordance with one embodiment of the disclosure. The printer apparatus 100 includes a computer control unit 1 that interfaces with sensors, actuators, and heaters and controls the operation of various components and features of the printer, including but not limited to temperatures, positioning capabilities, and movement of a glass fiber 11.

The apparatus includes a fiber handling unit 2. This unit contains a reel of fine glass fiber 11 (10-1000 microns in diameter, made of conventional soda-lime glasses, borosilicates, fused silica, or any other glass formulation), which may be rotated in any by a motor controlled by the computer control unit 1. The motor is capable of winding or unwinding the glass fiber as directed by the computer control unit.

In some embodiments, the fiber handing unit incorporates sensors in communication with and interfaced to the computer control unit 1. In one embodiment the incorporated sensor is a sensor for measuring fiber tension. In other embodiments the incorporated sensor is for detecting breakage of the fiber. In some embodiments the fiber handling unit 2 incorporates both a tension sensor and a breakage sensor.

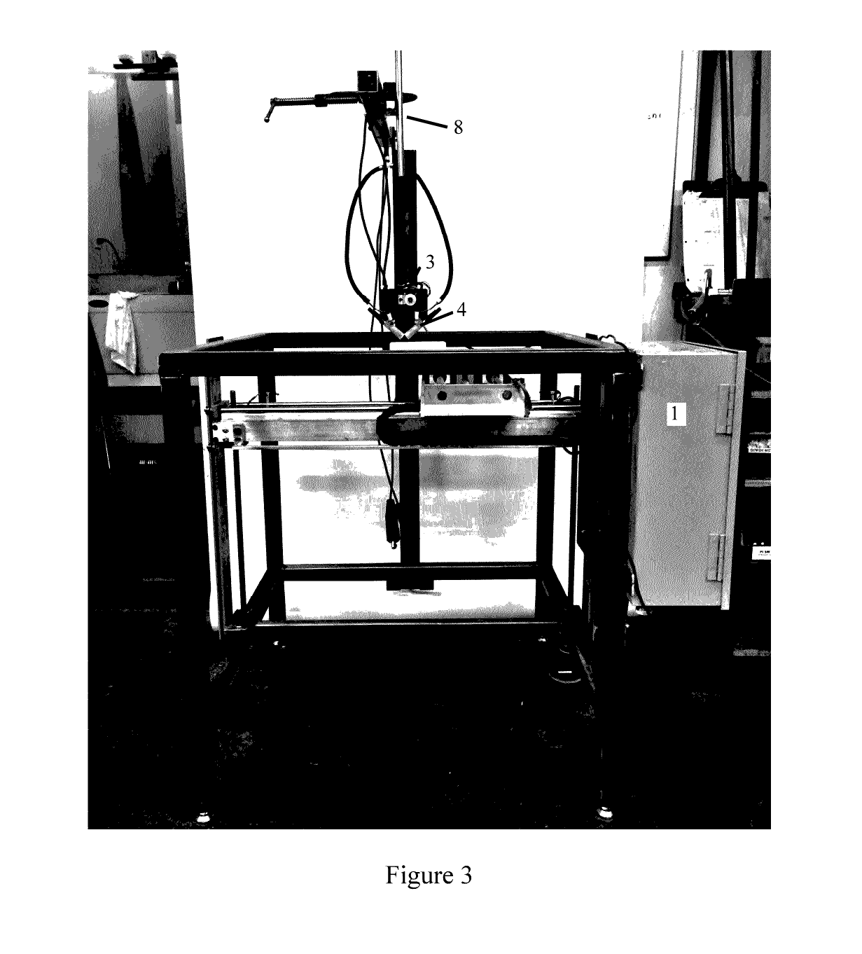

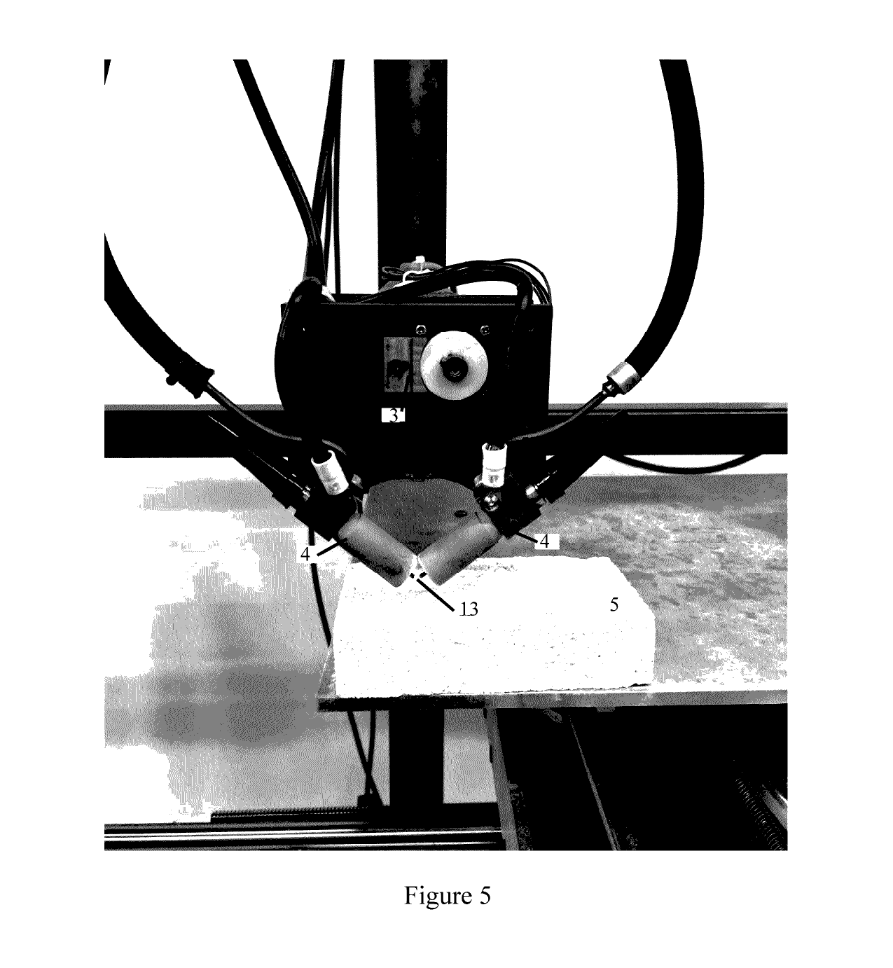

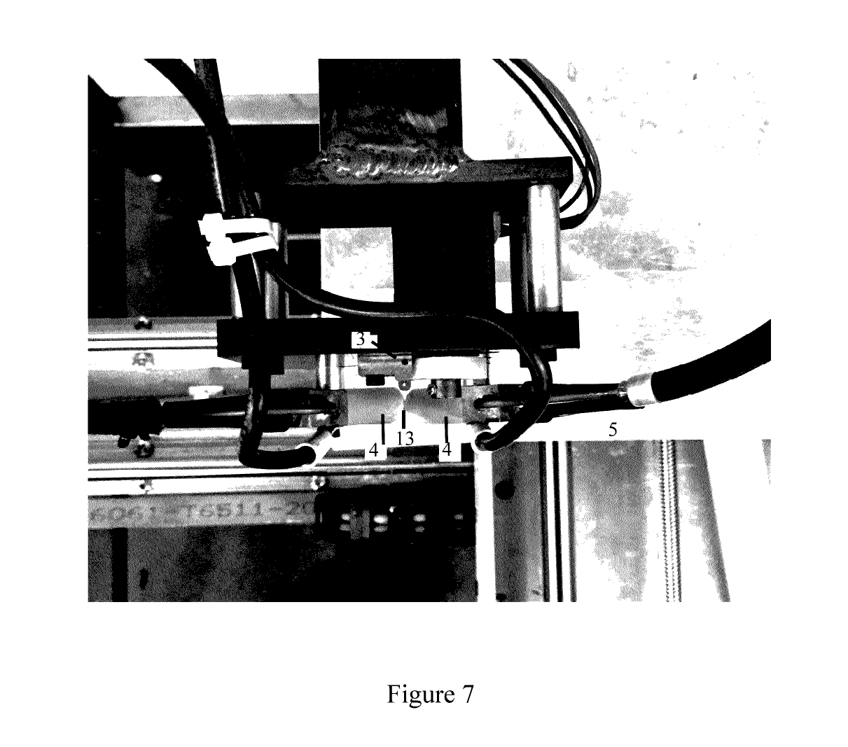

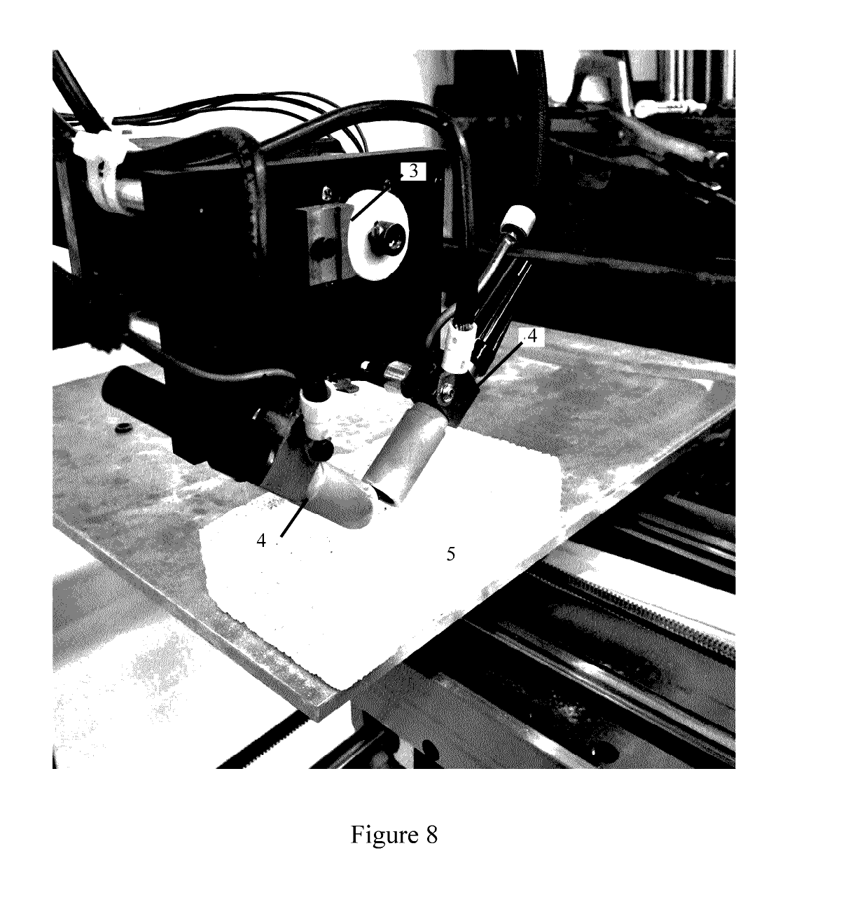

The apparatus also includes a fiber feed unit 3. In some embodiments, as illustrated in FIG. 3, FIG. 5, FIG. 7, and FIG. 8, the fiber feed unit 3 contains a motor-controlled wheel assembly that grips the fiber entering the unit from the fiber handing unit 2 and advances the glass fiber 11.

In some embodiments, the printing apparatus includes a fiber tube 8 positioned between the fiber handling unit 2 and fiber feed unit 3. The fiber tube 8 guides the glass fiber 11 from the fiber handing unit 2 to substantial alignment with the fiber feed unit 3. In this embodiment, the fiber feed unit 3 receives the guided glass fiber 11 from the fiber tube 8 and controls the movement of the glass fiber 11.

The primary function of the fiber feed unit 3 is to advance the glass fiber 11 towards a heating zone 13 of a heat source 4 and advance glass fiber 11 at a grow rate or deposition rate as described in more detail below.

In some embodiments, the fiber feed unit 3 includes sensors in communication with and interfaced to the computer control unit 1. In one embodiment the incorporated sensor is a sensor for measuring fiber tension. In other embodiments, the incorporated sensor is for detecting breakage of the fiber. In some embodiments, the fiber feed unit 3 incorporates both a tension sensor and breakage sensor.

The printing apparatus 100 also includes a primary heat source 4 for heating the glass fiber 11 ejected from the fiber feed unit 3. The primary heat source 4, heats the tip of the glass fiber 11 entering the heating zone 13, creating a molten glass droplet 9 attached to the end of the glass fiber 11 by surface tension. The primary heat source 4 may utilize a combination of convection and radiation to transfer energy to the glass fiber 11, and is controlled by the computer control unit 1. The primary heat source 4 may heat the glass fiber to any temperature which is suitable for melting the glass fiber and for depositing the melt fiber on a surface or substrate.

The heat source 4 may include an oxygen-fuel (propane, hydrogen, or any flammable gas) flame, a stream of gas (argon, nitrogen, hydrogen, or air) heated with a resistive element or electrical discharge, lasers, or infrared radiation from resistive elements or electrical discharge, an electric arc or a combination thereof. In some embodiments, a mechanism for temperature measurement may be included. In one embodiment, the mechanism for temperature measurement is internal to the primary heat source 4. In other embodiments the mechanism for temperature measurement may be described as a non-contact optical measurement of the temperature of the glass fiber.

In some embodiments, the apparatus includes multiple heat sources to heat the glass fiber.

The printing apparatus 100 further includes a deposition surface 5. In some embodiments, the deposition surface 5 is a flat surface to which molten glass produced by the apparatus by the heat source adheres. The deposition surface is composed of ceramic, glass, ceramic fiber, glass fiber, or a refractory metal. In some embodiments, the deposition surface includes an internal heat source composed of a resistive heating element and a temperature sensor, allowing the temperature of the surface to be controlled by the computer control unit 1.

In some embodiments, the printing apparatus 100 includes a positioning device 6. The positioning device 6 includes a mechanical and electrical system for controlling the position of the fiber feed unit 3 and heat source 4 relative to the deposition surface 5 with respect to three linear axes. In some embodiments, the position also includes one to three angular axes.

In other embodiments, the printing apparatus 100 includes a positioning device 6 and a print head 12. In one embodiment, the print head includes the fiber feed unit 3 and heat source 4. In one embodiment the print head 12 includes fiber feed unit 3, heat source 4 and fiber tube 8. In one embodiment the print head 12 includes fiber feed unit 3, heat source 4, fiber tube 8 and fiber handling unit 2. The positioning device 6 includes a mechanical and electrical system for controlling the position of the print head 12 relative to the deposition surface 5, with respect to three linear axes. In some embodiments, the position also includes one to three angular axes.

In some embodiments, the printing apparatus 100 includes an enclosure 7. The enclosure 7 is made of heat-resistant material and contains and insulates the deposition surface 5. In some embodiments, the enclosure 7 contains portions or all of the positioning unit 6. In some embodiments, the enclosure 7 is equipped with its own heat source and temperature measurement device allowing the computer control unit 1 to regulate the ambient temperature within the enclosure. In some embodiments, all or portions of the fiber feed unit and primary heat source are include in the enclosure 7.

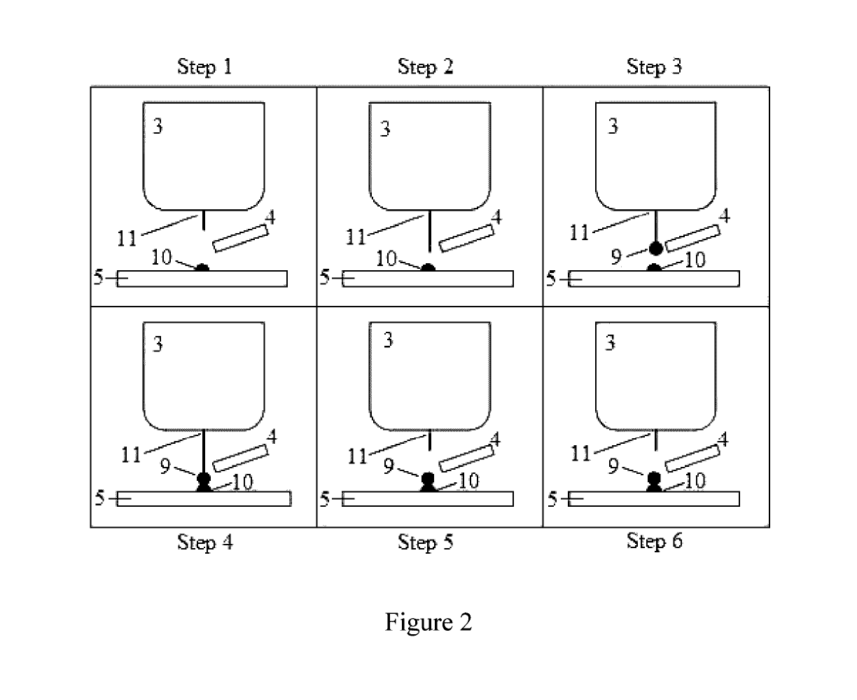

As illustrated in FIG. 2, the printing apparatus fabricates a glass object 10 by successively layering molten glass droplets 9. In some embodiments, the heat source is used to fuse new molten glass droplets with those already deposited 10 to the deposition surface 5.

Also provided herein are methods for printing glass to a deposition surface. The methods contemplated herein use any of the apparatus and examples as described above.

Generally, provided herein is a method for printing following the steps of FIG. 2.

Step 1 of FIG. 2 illustrates the position of glass fiber 11 and primary heat source 4 at the start of the deposition cycle. The tip of the glass fiber 11 is well above the heating zone of the primary heat source 4.

Step 2 of FIG. 2 shows the tip of the glass fiber 11 advanced by the fiber feed unit 3 such that the tip of the fiber is positioned in the heating zone of the primary heat source 4.

Step 3 of FIG. 2 illustrates the formation of a small droplet of molten glass (9) as the glass fiber 11 ejected from the fiber feed unit 3 melts.

Step 4 of FIG. 2 illustrates the attachment of the molten glass droplet 9 to the glass object 10 currently being fabricated. This action takes place via a combination of the fiber feed unit 3 advancing the glass fiber 11 and positioning system 6 aligning the fiber feed unit to the proper (x, y) coordinate of the deposition surface 5. In some embodiments, the deposition surface 5 is raised to meet the molten glass drop 9.

Step 5 of FIG. 2 illustrates detachment of the molten droplet 9 from the glass fiber 11. This action takes place via a combination of the of the fiber feed unit 3 retracting the glass fiber 11 and positioning system 6 aligning the fiber feed unit to the proper (x, y) coordinate of the deposition surface 5. In some embodiments, the deposition surface 5 is lowered.

Step 6 of FIG. 2 illustrates the fusion of the molten glass droplet 9 and a previously deposited molten glass droplet, now solidified.

In some embodiments, before the deposition process begins, the computer control unit 1 increases the temperature of an enclosure 7 (if a heat source is included within the enclosure) and the deposition surface 5 to a standard operating temperature. In one embodiment the temperature of the enclosure and deposition surface may be any temperature suitable to control the rate of cooling of the molten glass droplet and/or solidified glass. By controlling the rate of cooling for a longer period of time, the molten glass may be deposited in a manner that allows for reducing the amount of stress introduced into the printed glass.

In some embodiments of the deposition process, the computer control unit 1 causes the positioning device 6 to change the position of the fiber feed unit 3 and primary heat source 4 relative to the deposition surface 5. The fiber feed unit 3 advances the glass fiber 11 which is supplied by the fiber handling unit 2 through the fiber tube 8 and into the heating zone 13 of the primary heat source 4. As the fiber melts proximate to the primary heat source, the glass's surface tension retains the molten material on the end of the glass fiber 11, causing a small droplet of molten glass 9 to form. The droplet of molten glass 9 is suspended by the rigid glass fiber 11. The glass fiber 11 is continually fed into the heating zone 13 at a speed synchronized to the rate at which the newly-fed fiber melts. During this stage, the droplet remains stationary in the heating zone. As the droplet of molten glass 9 accumulates more molten material, the droplet grows in size.

The glass fiber 11 is typically 50-500 microns in diameter, although glass fibers having a smaller or larger diameter may also be used. This range tends to allow for the glass fiber to be flexible enough to be wound and unwound on a reel and transported between units of the printing apparatus at different locations, but ridged enough to support a molten glass droplet 9 and accurately transfer the molten droplet to a desired location on the deposition surface 5 or deposited glass structure 10.

Once the molten glass droplet 9 reaches a desired size, the fiber feed unit 3 quickly advances the glass fiber 11, at a deposition rate which is faster than the grow rate, to the deposition surface 5. In certain embodiments, the size of the molten glass droplet 9 is between 0.1 mm to 2 mm diameter and is controlled by accuracy of the diameter of the glass fiber 11, although molten glass droplets having a smaller or larger diameter may also be created. In some embodiments, the deposition surface is rapidly raised by the positioning system. This action causes the molten glass droplet 9 to make contact with the deposition surface 5, or previously deposited glass structures 10. This contact causes the molten glass droplet 9 to adhere to the deposition surface 5 or deposited glass structure 10. Once the deposition of the droplet has occurred, the fiber feed unit 3 rapidly retracts the glass fiber out of the heating zone 13. In some embodiments, the deposition surface is rapidly lowered by the positioning system. This retraction action detaches the molten glass droplet 9 from the glass fiber 11.

In some embodiments, the deposition surface is positioned so that heat from the primary heat source 4 radiates to the deposition surface to cause additional fusion between the newly deposited droplet and the previously deposited glass 10.

Via repetition of the previously described process, as controlled by the computer 1, a glass structure 10 is formed on the deposition surface 5.

In some embodiments after the process is finished, the temperature of the enclosure 7 is slowly lowered to ambient temperature, with the rate of cooling controlled by 1. This serves to reduce internal stresses and anneal the glass structure.

For glasses with low coefficients of thermal expansion and favorable mechanical properties, such as borosilicate or fused silica, the control of ambient temperature of the enclosure 7 is not required, as such materials are relatively unaffected by rapid cooling and thermal stresses.

In some embodiments, in order to accommodate printing in multiple glass formulations including glasses possessing a variety of colors, physical, mechanical, thermal, or chemical properties, components of the printing apparatus may be duplicated. Such components include the fiber handling unit 2, fiber feed 3, primary heat source 4, and fiber transport tube 8. Printing in multiple glass formulations and varying colors may be performed to provide an aesthetic effect.

In some embodiments, when printing apparatus is capable of printing multiple materials, the droplet deposition processes from multiple glass fibers takes place simultaneously.

In some embodiments, the apparatus may be used to print temporary glass structures around the primary glass structure. Temporary glass structures may be deposited in such a way that they provide mechanical support for the object being fabricated and are removable after the completion of the process. This can be accomplished by using glasses with varying coefficients of thermal expansion for the primary object and support structure. Removal of support structures may be facilitated by the automatic formation of fractures upon cooling.

In other embodiments, combinations of incompatible glasses may be used to introduce mechanical stress in a finished object, thereby strengthening it, in a process analogous to existing methods of tempering glass.

In some embodiments, for fine control over the geometry of the deposited glass, the droplet size and the length of time spent in the fusion step may be altered.

As the molten region of the glass fiber is never in contact with any object during the droplet formation phase, no impurities are introduced into the glass fiber (as would be if a nozzle or crucible were to be used) and no nucleation points are provided. This allows for the manufacture of exotic glass formulations which would normally not be possible to create using conventional processes. Such conventional processes, that is, processes which utilize a nozzle or crucible, tend to provide a high alumina glass formulation which is considered to be a relatively impure glass formulation.

As the deposition of glass fibers is a discontinuous process, the geometry of the glass structure that is formed is not limited only to objects consisting of a single, continuous deposition path and the issue of glass fibers being accidentally deposited between discontinuous regions of deposition (stringing) is avoided.

### EXAMPLE 1

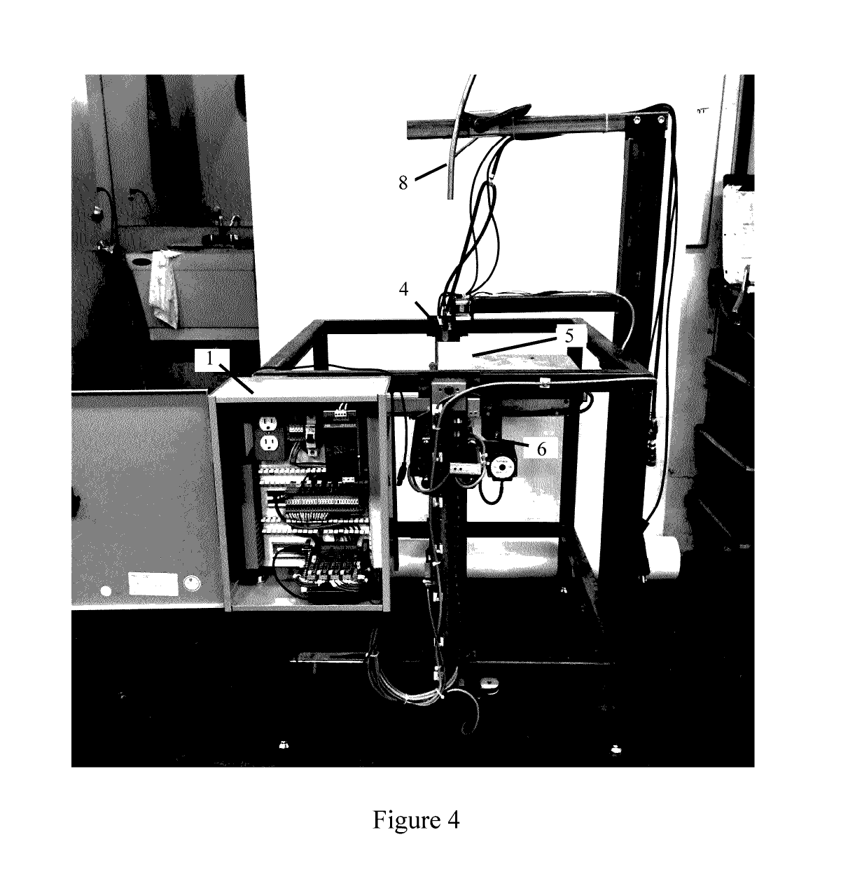

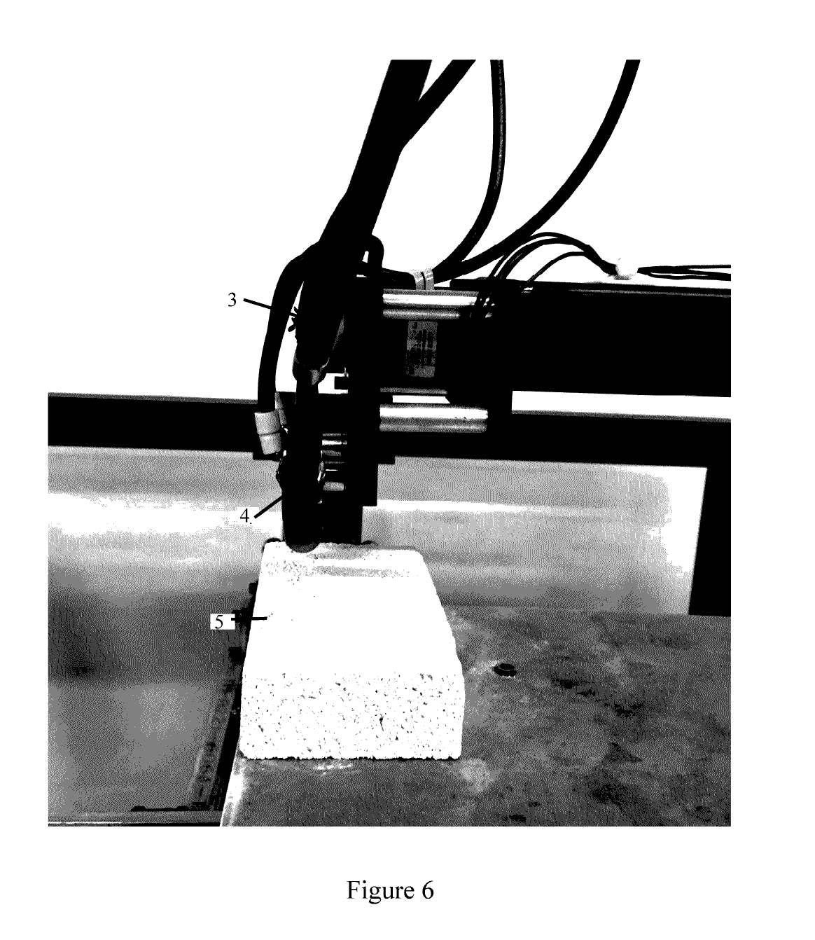

FIGS. 3-8 show an experimental printing apparatus. The experimental apparatus includes a computer control unit 1, a fiber source (not pictured), a fiber feed unit 3, a fiber tube 8, a primary heat source 4 comprising two spaced apart electrodes from a commercial tig welder with a high frequency start, a defined heating zone 13 between the two spaced apart electrodes 4, a deposition substrate 5 and a positional unit 6. The spaced apart electrodes create an electric arc to heat the glass fiber. Glass fiber from the source was guided though fiber tube 8 into an aperture of the fiber feed unit 3 and into the heating zone 13 for heating.

### EXAMPLE 2

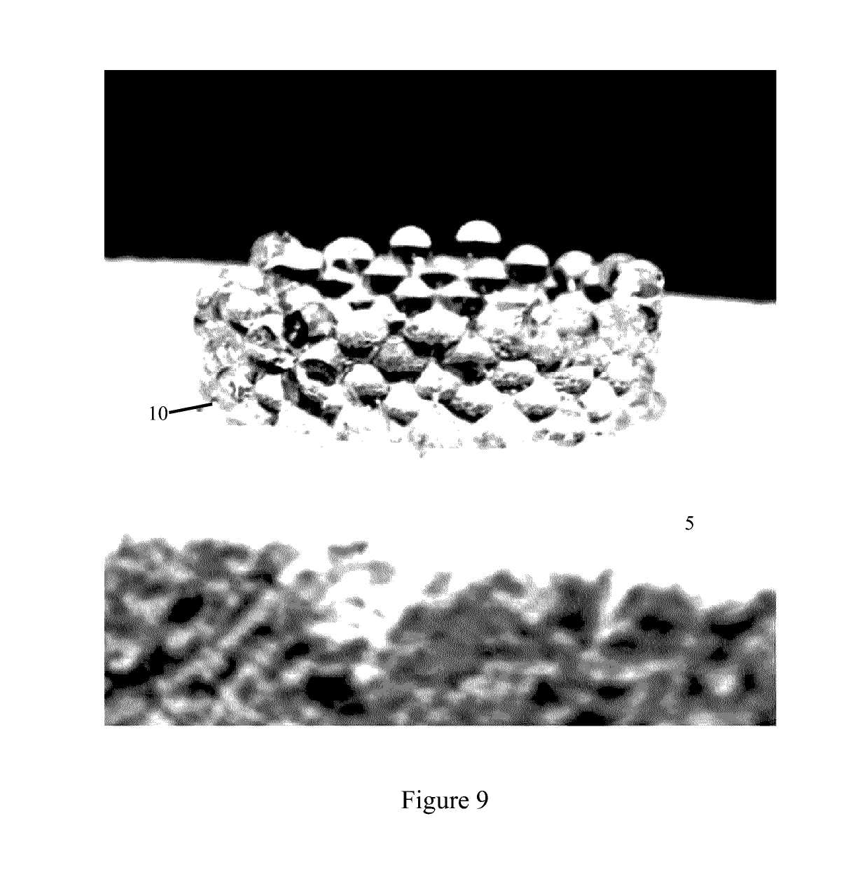

A glass structure, as seen in FIG. 9, is a cylinder made by the following method. The glass structure was designed in a CAD environment and converted to a set of instructions, similar to an STL file, for the computer control unit to run. The glass structure was created using the experimental printing apparatus of Example 1 and an electric arc as the primary heat source. Two spaced apart electrodes 4 of a tig welder defined the heating zone 13. The electric arc was created with the following characteristics: 5 amps A/C 400 htz, 15 volts, in an Argon atmosphere. The arc path-length was about 1 cm in length. Glass fiber was advanced into the arc/heating zone 13 and a droplet formed. The fiber was advanced at a speed synchronized to the rate at which the newly-fed glass fiber melted and the glass droplet grew in size. The glass fiber was then rapidly advanced while the deposition surface 5 was simultaneously raised and the molten drop was deposited on deposition surface. Subsequent molten drops were deposited on the deposition surface on previously deposited and solidified droplets. The printer was capable of creating glass objects and layers with a resolution of 0.25 to 2 mm with a tolerance of about 50 microns. The tolerance was highly dependent on the uniformity of the glass fiber.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention.

What is claimed is:

1. An apparatus for printing glass comprising:
a computer control unit which controls the operation of various components of the apparatus;
a fiber handling unit which operates as a supply source for glass fiber;
a fiber feed unit which advances glass fiber from the fiber handling unit towards a primary heat source and which retracts glass fiber from the primary heat source towards the fiber handling unit;
a heat source which melts an end tip of glass fiber creating a droplet of molten glass; and
a deposition surface for receiving droplets of molten glass.

2. The apparatus according to claim 1, wherein the fiber handling unit further comprises a motor, which rotates the fiber handing unit to wind or unwind a reel of glass fiber and is in communication with the computer control unit.

3. The apparatus according to claim 1 further comprising:
at least one tension sensor, wherein the at least one tension sensor measures the tension of the glass fiber and is in communication with the computer control unit, and wherein the at least one tension sensor is incorporated into the fiber handling unit, the fiber feed unit, or both the fiber handling and fiber feed units.

4. The apparatus according to claim 1, wherein the fiber feed unit comprises a motor-controlled wheel assembly in communication with the computer control unit that grips the glass fiber from the fiber handing unit and advances and retracts the fiber towards, through and away from the heat source.

5. The apparatus according to claim 1, wherein the fiber feed unit advances the fiber at a grow rate, synchronized to the rate at which a newly-fed fiber melts, to grow the molten glass droplet, located on the tip of the fiber, to a desired molten glass droplet size.

6. The apparatus according to claim 1, wherein the fiber feed unit advances the glass fiber, holding the molten glass droplet located on the tip of the fiber, at a deposition rate, faster than the rate at which a newly-fed fiber melts, to advance the molten glass droplet to contact the deposition surface.

7. The apparatus according to claim 1, further comprising a fiber tube, positioned between the fiber handling unit and fiber feed unit that guides the glass fiber from the fiber handing unit to alignment with the fiber feed unit.

8. The apparatus according to claim 1, wherein the deposition surface is raised to contact and accept a molten droplet of glass.

9. The apparatus according to claim 1, wherein the heat source is selected from the group consisting of an oxygen-fuel flame, a stream of gas heated with a resistive element, a stream of gas heated with electrical discharge, lasers, infrared radiation, an electric arc, or any combination thereof.

10. The apparatus according to claim 1, wherein the heat source is an electric arc created by two spaced apart electrodes, wherein the space between the electrodes defines a heating zone, wherein the electric arc is about 1 cm in length and the glass fiber is advanced into the heating zone and the electric arc heats the end tip of the glass fiber creating a molten glass droplet on the tip of the glass fiber.

11. The apparatus according to claim 1, wherein the fiber feed unit continuously advances the fiber at a grow rate synchronized to the rate at which a newly-fed fiber melts, to grow the molten glass droplet to a desired molten glass droplet size and selectively advances the glass fiber at a deposition rate to advance the molten glass droplet to contact the deposition surface.

12. The apparatus according to claim 1, wherein the apparatus comprises:
at least two fiber handling units which each operate to supply a different source of glass fiber and at least two fiber feed units each which advances a glass fiber from an associated fiber handling unit.

13. A method for printing glass on a material comprising:
providing a glass fiber;
feeding the glass fiber from a fiber handling unit;
advancing and retracting the glass fiber with a fiber feed unit;
heating an end tip of the glass fiber with a heat source to create a molten glass droplet; and,
depositing the molten glass droplet on a substrate surface,
wherein a computer control unit controls the operation of various components of the apparatus.

14. The method according to claim 13 further comprising:
winding and unwinding the glass fiber on a reel by a motor of the fiber handling unit in communication with the computer control unit.

15. The method according to claim 13, further comprising:
measuring the tension of the glass fiber by at least one tension sensor that is in communication with the computer control unit, and wherein the at least one tension sensor is incorporated into the fiber handling unit, the fiber feed unit, or both the fiber handling and fiber feed units.

16. The method according to claim 13, further comprising:
gripping the glass fiber and advancing and retracting the glass fiber towards, through and away from the heat source.
guiding the glass fiber with a fiber tube, positioned between the fiber handling unit and fiber feed unit, from the fiber handing unit to alignment with the fiber feed unit.

17. The method according to claim 13 further comprising:
continuously advancing the glass fiber at a grow rate, to grow the molten glass droplet to a desired size and
advancing the glass fiber at a deposition rate, to advance the molten glass droplet held by the glass fiber to the deposition surface.

18. The method according to claim 13, wherein heating is accomplished by creating an electric arc between two spaced apart electrodes, wherein the space between the electrodes defines a heating zone and wherein creating the molten glass droplet is accomplished by advancing the glass fiber such that the tip of the fiber is located in the heating zone of the electric arc.

19. The method according to claim 13, further comprising:
heating the tip of the glass fiber with an electric arc in a heating zone, wherein the heating zone is defined by the space between two spaced apart electrodes;
growing the molten glass droplet to a desired size by continuously advancing the glass fiber at a grow rate synchronized to the rate at which a newly-fed fiber melts, while keeping the molten glass droplet in the heating zone; and
depositing the molten glass droplet on a deposition surface by advancing the glass fiber at deposition rate, faster than the rate at which a newly-fed fiber melts, advancing the glass fiber and molten glass droplet though the heating zone.

20. The method according to claim 13, further comprising:
providing at least two glass fibers;
feeding each of the glass fibers from an associated fiber handling unit;
advancing and retracting each of the glass fibers with an associated fiber feed unit;
selectively advancing one of the glass fibers to a heating zone of a heat source;
heating an end tip of one of the glass fibers with a heat source to create a molten glass droplet; and
depositing the molten glass droplet on a substrate surface;
wherein a computer control unit controls the operation of various components of the apparatus, and selects which of the at least two glass fibers to advance.

21. The method according to claim 20, wherein at least two of the glass fibers have different coefficients of thermal expansion, wherein at least one glass fiber is deposited as a fabrication object and at least one glass fiber is deposited as a removable mechanical support structures and wherein the removal of the mechanical support structures are facilitated by the automatic formation of fractures upon cooling of the deposited mechanical support structures.
